(19) United States
(12) Patent Application Publication
(10) Pub. No.: US 2016/0018011 A1
(43) Pub. Date: Jan. 21, 2016

(54) SINGLE LEVER CARTRIDGE

(71) Applicant: Fluehs Drehtechnik GmbH, Luedenscheid (DE)

(72) Inventor: Lutz LANGE, Luedenscheid (DE)

(73) Assignee: Fluehs Drehtechnik GmbH, Luedenscheid (DE)

(21) Appl. No.: 14/770,743

(22) PCT Filed: Sep. 23, 2013
(86) PCT No.: PCT/EP2013/069745

§ 371 Date: Aug. 26, 2015

(30) Foreign Application Priority Data
Mar. 1, 2013 (EP) 13157471.7

(51) Int. Cl. F16K 11/078; F16K 31/60; F16K 27/04

(52) U.S. Cl. CPC F16K 11/0787; F16K 27/045; F16K 31/602

(57) ABSTRACT

A single lever cartridge includes a head piece which receives a base piece, and a disc control having a control disc, which is disposed so as to be rotatable and movable via a rotatably and pivotably mounted spindle, wherein the end portion of the head piece which receives the base piece is designed in such a way that the end portion is at least flush at least in some regions with the base surface of the base piece facing away from the control disc.

The invention relates to a single-lever cartridge comprising a head piece that accommodates a bottom piece, as well as a disk controller having a control disk that is disposed so that it can be rotated and/or displaced, by way of a spindle mounted so that it can be rotated and/or pivoted.

Single-lever cartridges structured as mixer cartridges are frequently used in sanitary fittings, in which a control disk as well as a disk controller having a pass-through disk are disposed, which cartridge can be operated by way of a single lever, in such a manner that not only the amount of water but also the water temperature can be controlled by way of one and the same lever. Such interchangeable cartridges can be used in fitting housings having different structures.

In the configuration of fitting housings, there is increasingly a desire for the smallest possible structure. For this reason, it is necessary to construct the mixer cartridges in small and compact manner, wherein simultaneously, the demand for a large amount of water exists. Mixer cartridges are regularly composed of plastic injection-molded parts, wherein because of the small dimensioning of the components, connected with generously dimensioned passage openings to allow water to pass through, only small material thicknesses are present in some regions. The mixer cartridges are biased against a valve seat in the fitting housings, in order to guarantee the required seal. Biasing regularly takes place by way of a fastening ring, which is disposed on its end of the head piece of the mixer cartridge that lies opposite the valve seat, and is screwed into the fitting housing, thereby achieving the bias.

It is a disadvantage of the previously known mixer cartridges that because of the bias, deformations of the bottom piece of the mixer cartridge, which is regularly produced from plastic, can occur, and thereby the seal between mixer cartridge and valve seat can be impaired.

This is where the invention wants to provide a remedy. The invention is based on the task of making available a single-lever mixer cartridge of the aforementioned type, in which deformation of the bottom piece in the fixed state is avoided. According to the invention, this task is accomplished in that the end-side section of the head piece that accommodates the bottom piece is configured in such a manner that it is at least flush with the bottom surface of the bottom piece that faces away from the control disk, at least in certain regions.

With the invention, a single-lever mixer cartridge is created, in which deformation of the bottom piece in the fixed state of the mixer cartridge is avoided. By means of the configuration of the head piece in such a manner that the end-side section of the head piece that accommodates the bottom piece is configured in such a manner that it is at least flush with the bottom surface of the bottom piece that faces away from the control disk, at least in certain regions, or preferably projects beyond it, at least in certain regions, the result is brought about that this end-side section lies on the valve seat. The bracing forces are directly transferred to the valve seat directly, in this manner, thereby avoiding settling effects of the bottom piece that is formed of plastic. For uniform transfer of the bracing forces to the valve seat of a fitting, the end-side section of the bottom surface of the bottom piece projects, particularly preferably completely, beyond the bottom surface of the bottom piece, wherein recesses, into which the fastening steps of the bottom piece engage for their anti-rotation fixation, can be ignored. It is essential that the bottom piece does not project beyond the end-side section of the head piece at any location.

In a further development of the invention, the bottom piece accommodates at least one seal for a seal relative to a valve seat of a fitting that projects beyond the end-side section of the head piece. In this way, defined deformability of the seal is achieved, thereby guaranteeing a reliable sealing effect. Thus, damage to the seal due to excessive bracing is avoided.

In a further embodiment of the invention, the mantle surface of the bottom piece is formed, in certain regions, by a section of a seal. In this way, small component dimensioning of the bottom piece is achieved.

In a further development of the invention, the bottom piece is configured in such a manner that the center point of the bottom piece lies on the plane of its bottom surface and is not formed by a seal. In this way, impairment of the seal or of the sealing contact surface due to production tolerances of the valve seat is avoided; these tolerances are caused during the course of production, for example by means of the centering tip of the drill.

In a further embodiment of the invention, the upper valve part is configured as a side discharge valve. In the design of fittings, a side water discharge is also often required. Such a side water outlet is implemented in that the bottom of the mixer cartridge is configured in such a manner that the exiting water can exit between the bottom piece of the cartridge and the bottom of the accommodation of the fitting, and can be passed through the side discharge of the fitting.

The invention furthermore relates to a fitting having a cartridge accommodation having a valve seat, into which fitting such a mixer cartridge is introduced, wherein the head piece is braced against the valve seat by way of a fastening ring that engages around the head piece on the outside, wherein the valve seat has a planar contact surface on which the end-side section of the head piece lies, in such a manner that the vertically acting bracing forces are transferred to the stop directly, by way of the head piece.

Other further developments and embodiments of the invention are indicated in the remaining dependent claims. Exemplary embodiments of the invention are shown in the drawings and will be described in detail below. The drawings show:

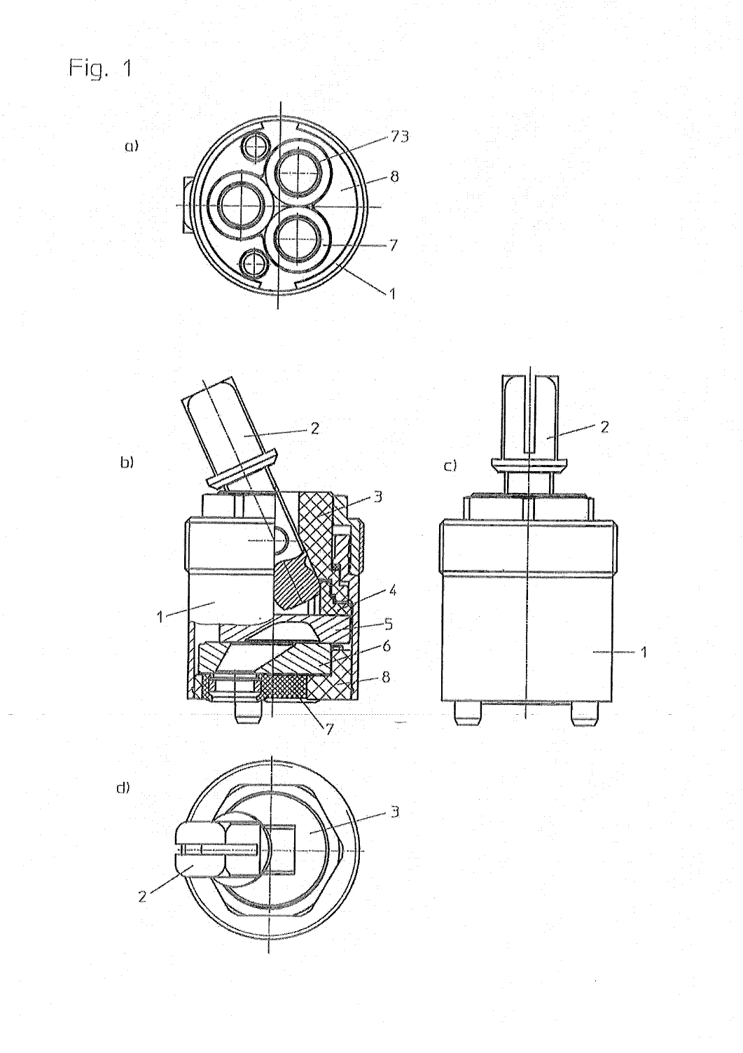

FIG. 1 the schematic representation of a single-lever mixer cartridge
a) in a view from below,
b) in partial longitudinal section,
c) in a side view;
d) in a top view;

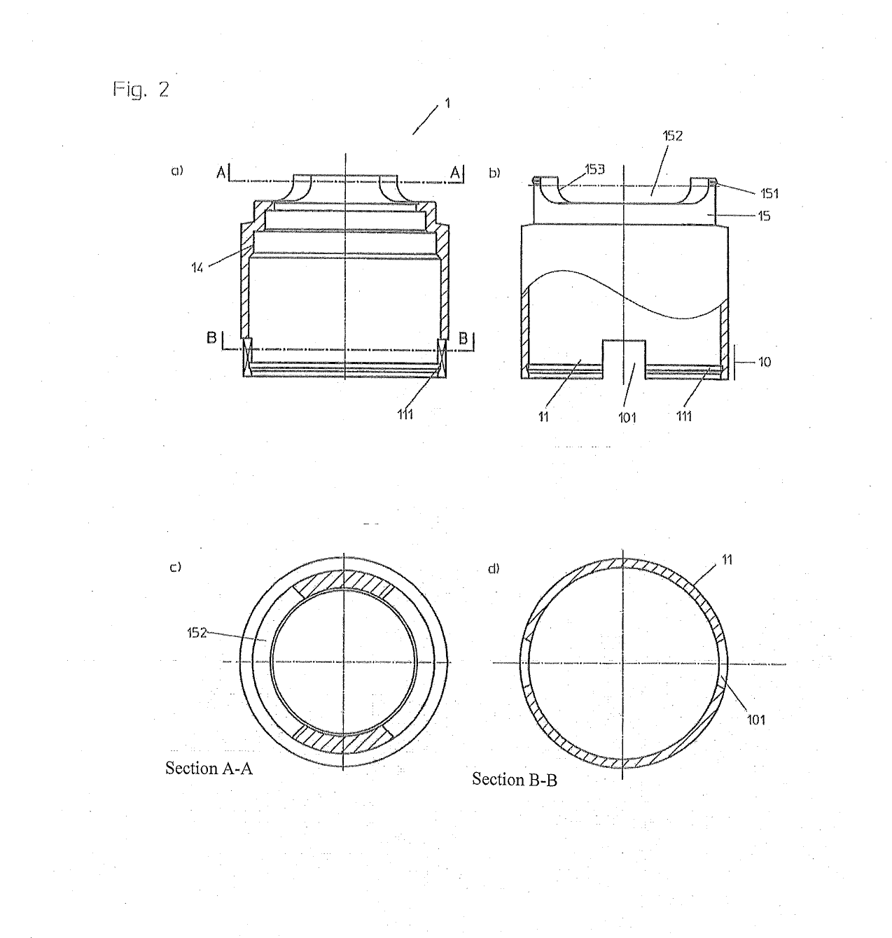

FIG. 2 the schematic representation of the head piece of the mixer cartridge from FIG. 1
a) in longitudinal section;
b) in partial section, in a side view rotated by 90°;
c) in cross-section (Section A-A);
d) in cross-section (Section B-B);

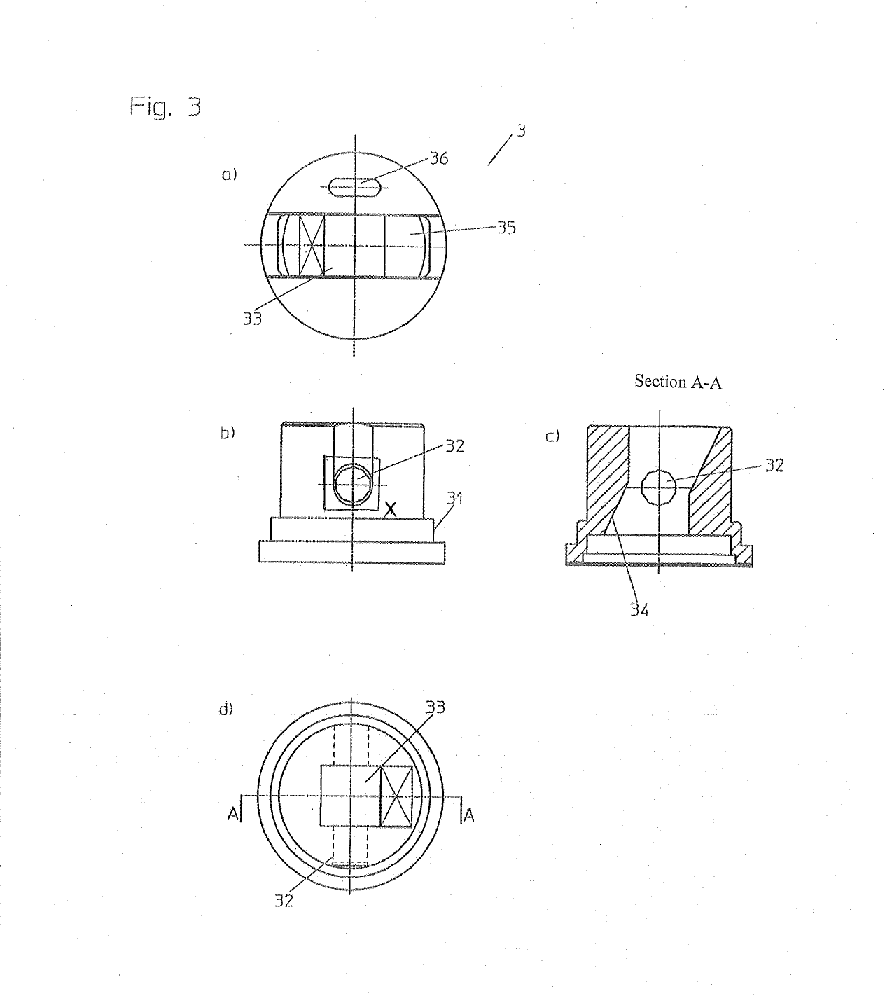

FIG. 3 the schematic representation of the spindle accommodation of the mixer cartridge from FIG. 1
a) in a top view;
b) in a side view;
c) in longitudinal section (Section A-A);
d) in a view from below;

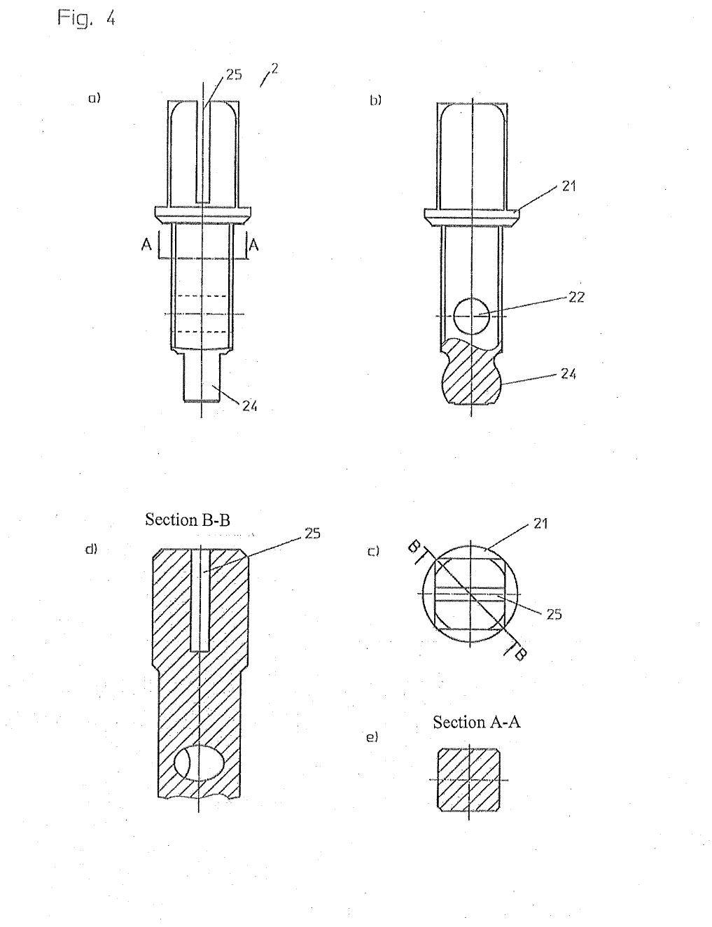

FIG. 4 the spindle of the mixer cartridge from FIG. 1
a) in a side view;
b) in partial section, in a side view rotated by 90°;
c) in a top view;
d) in longitudinal section (Section B-B);
e) in cross-section (Section A-A);

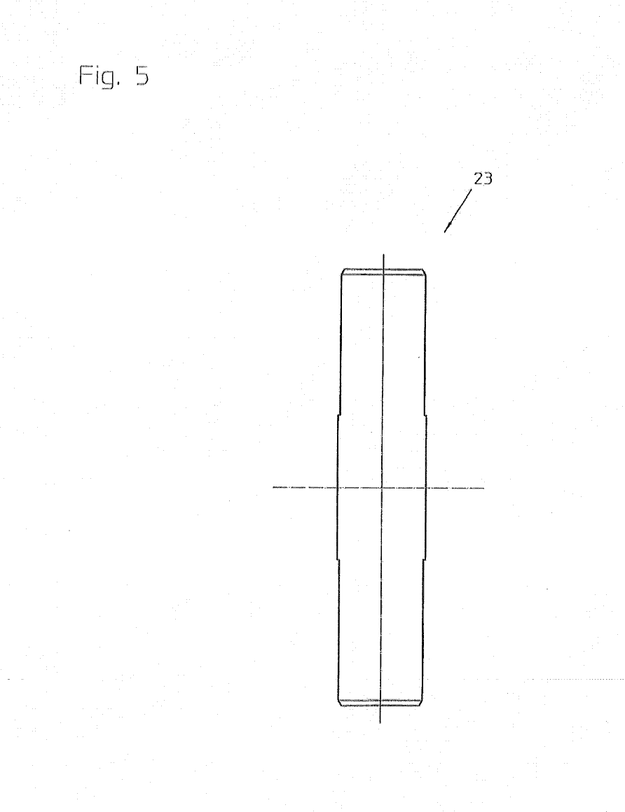

FIG. 5 the pivot axis of the spindle of the mixer cartridge from FIG. 1;

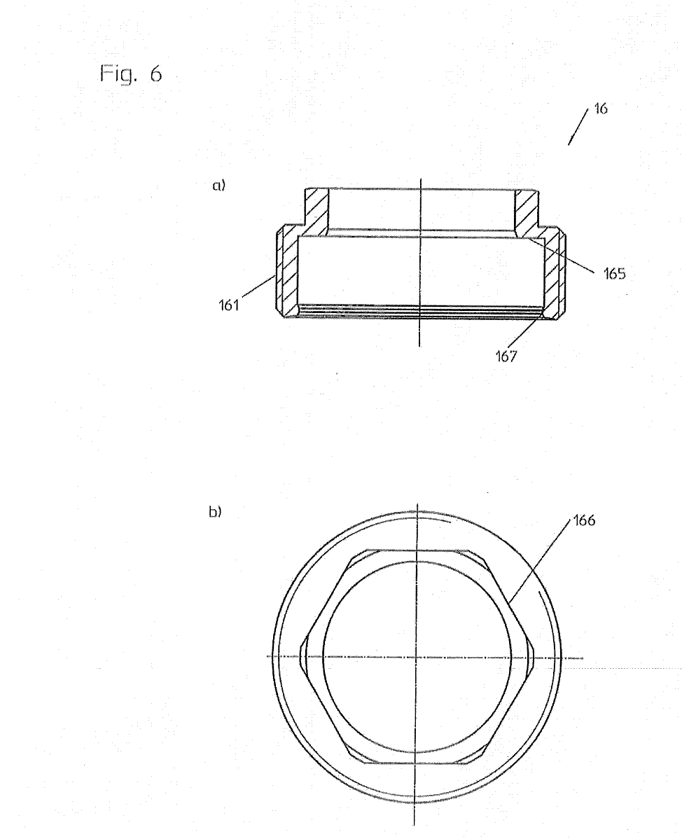

FIG. 6 the fastening ring of the mixer cartridge from FIG. 1
a) in longitudinal section;
b) in a top view;

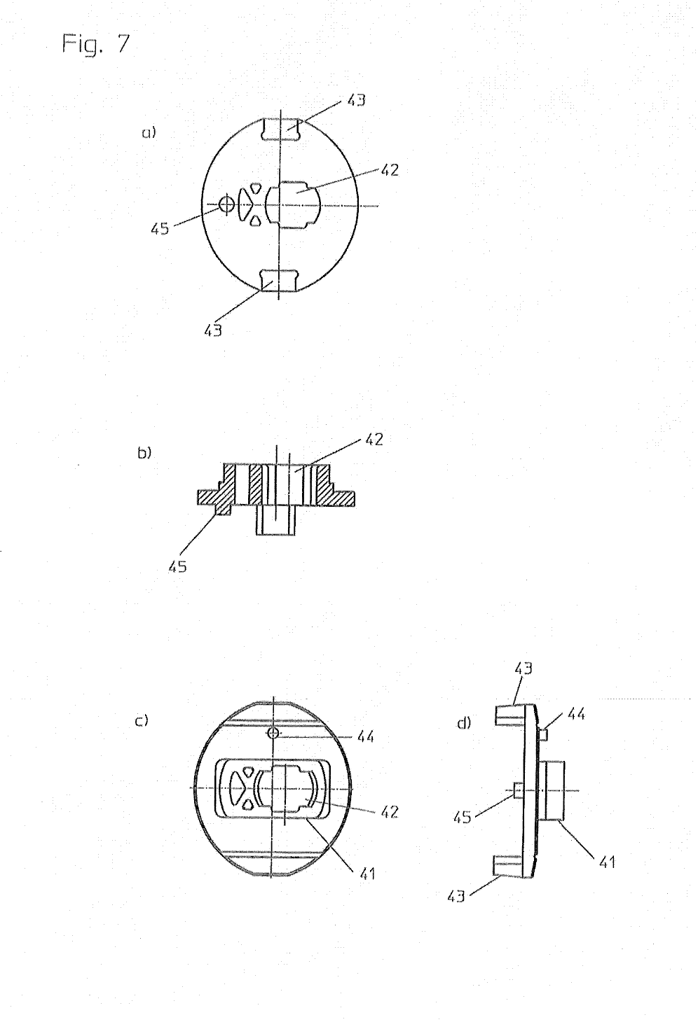

FIG. 7 the schematic representation of the slide piece of the mixer cartridge from FIG. 1
a) in a view from below;
b) in cross-section;
c) in a top view;
d) in a side view;

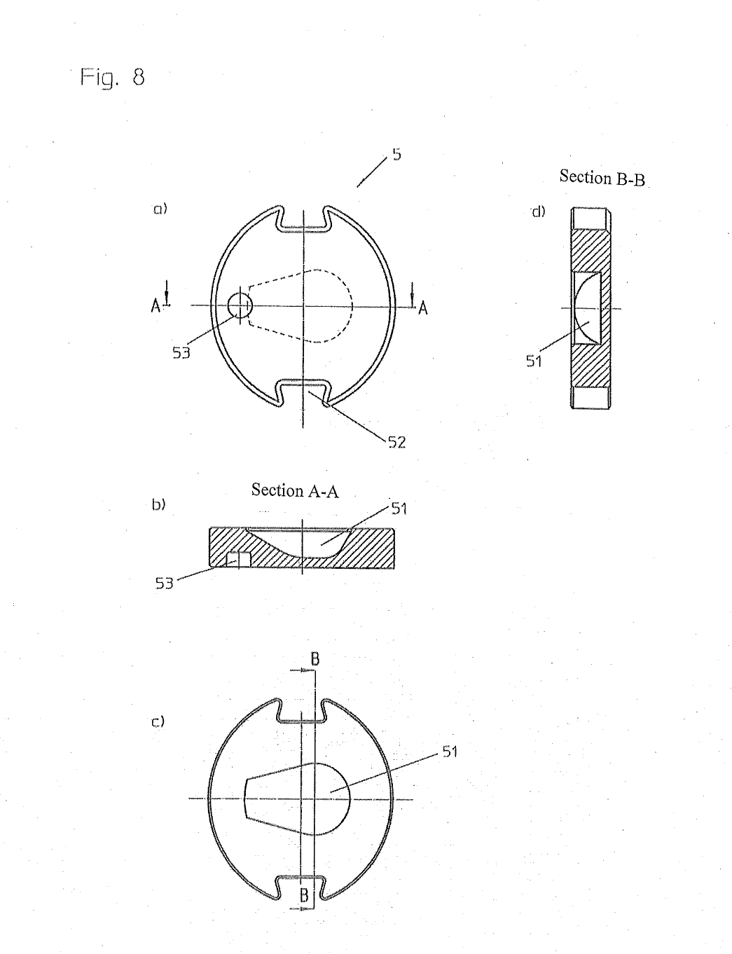

FIG. 8 the representation of the control disk of the mixer cartridge from FIG. 1
a) in a view from below,
b) in cross-section (Section A-A);
c) in a top view;
d) in cross-section (Section B-B);

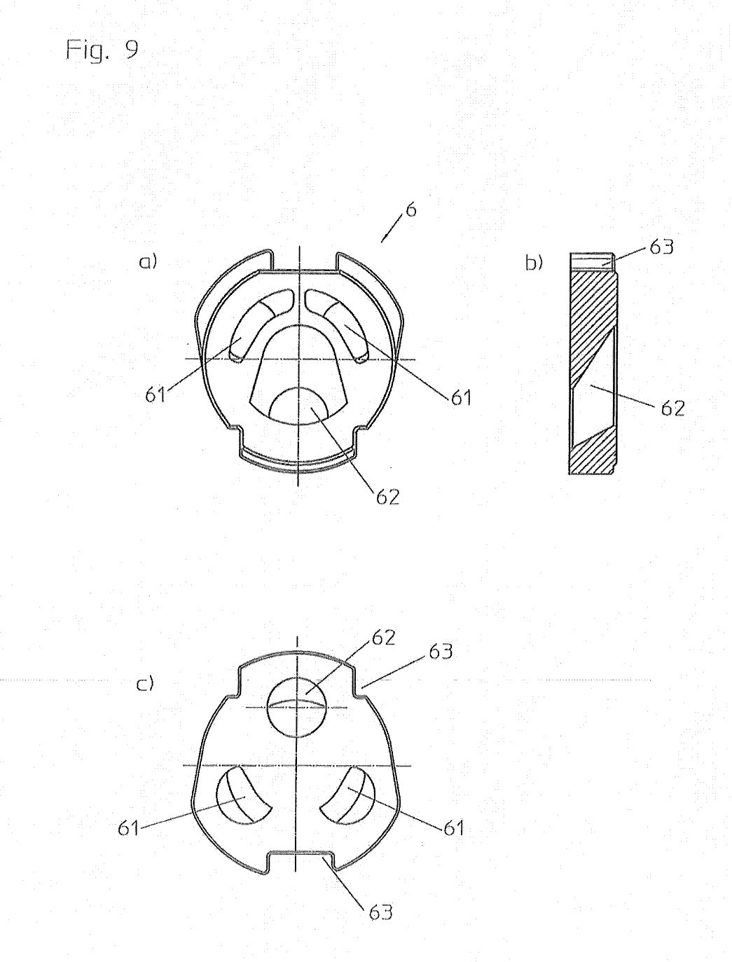

FIG. 9 the representation of the pass-through disk of the mixer cartridge from FIG. 1
a) in a view from below;
b) in cross-section;
c) in a top view;

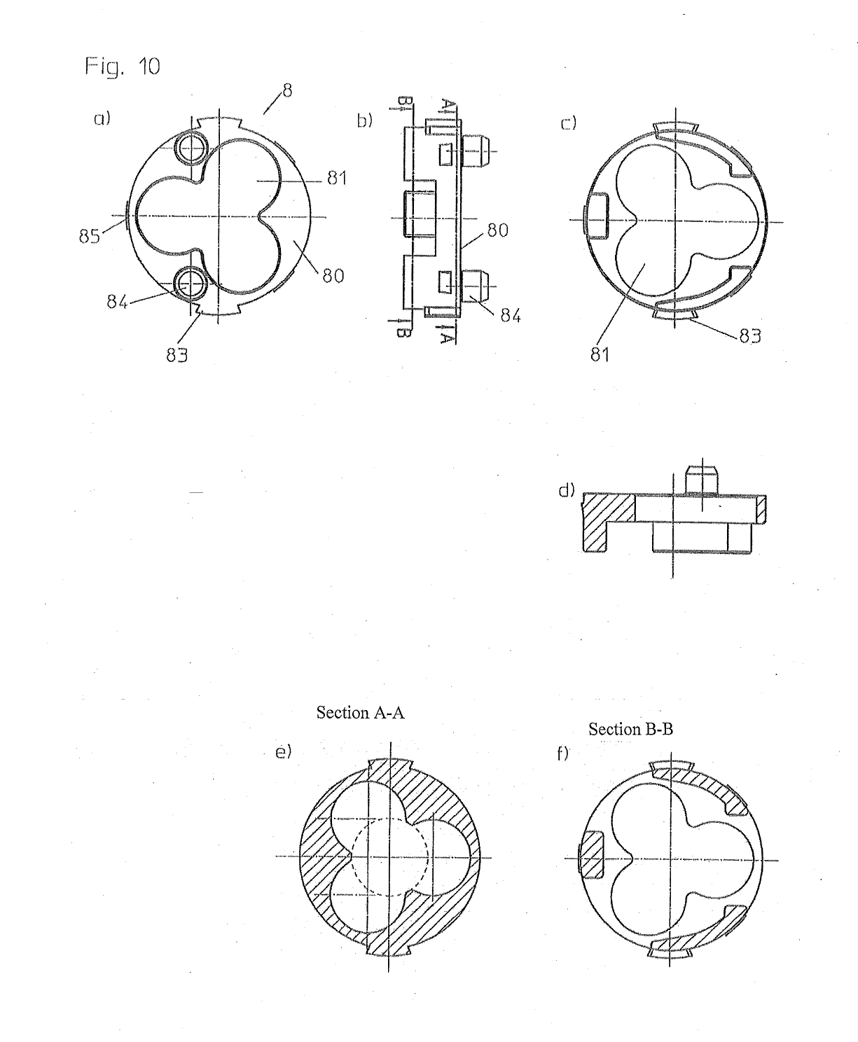

FIG. 10 the representation of the bottom piece of the mixer cartridge from FIG. 1
a) in a view from below;
b) in a side view;
c) in a top view;
d) in partial section;
e) in cross-section (Section A-A);
f) in cross-section (Section B-B);

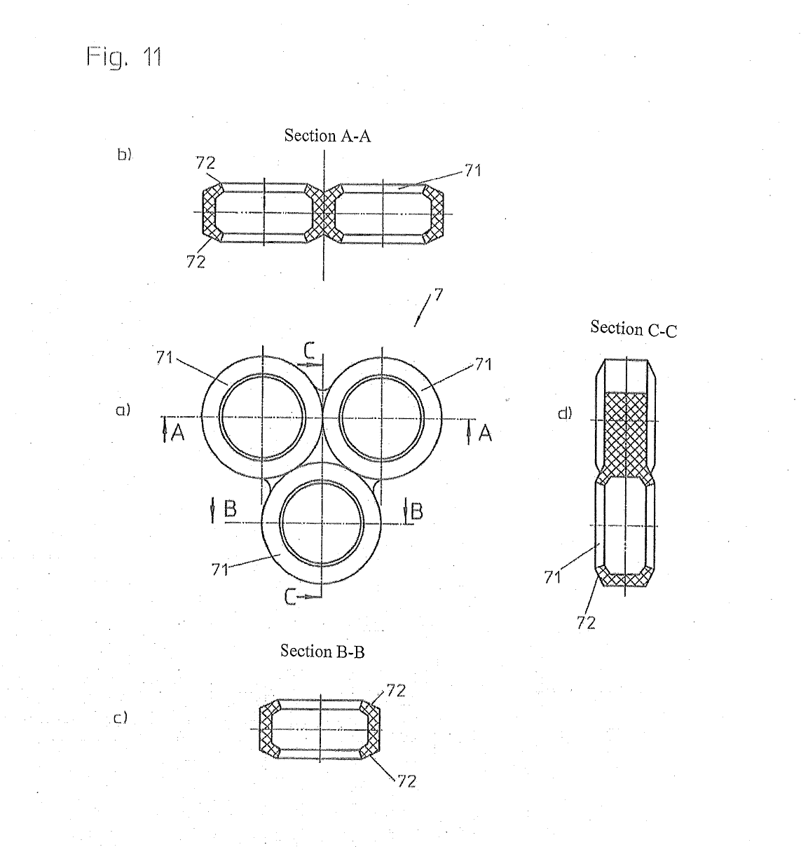

FIG. 11 the schematic representation of the molded lip seal part of the mixer cartridge from FIG. 1
a) in a top view;
b) in longitudinal section (Section A-A);
c) in longitudinal section (Section B-B);
d) in longitudinal section (Section C-C);

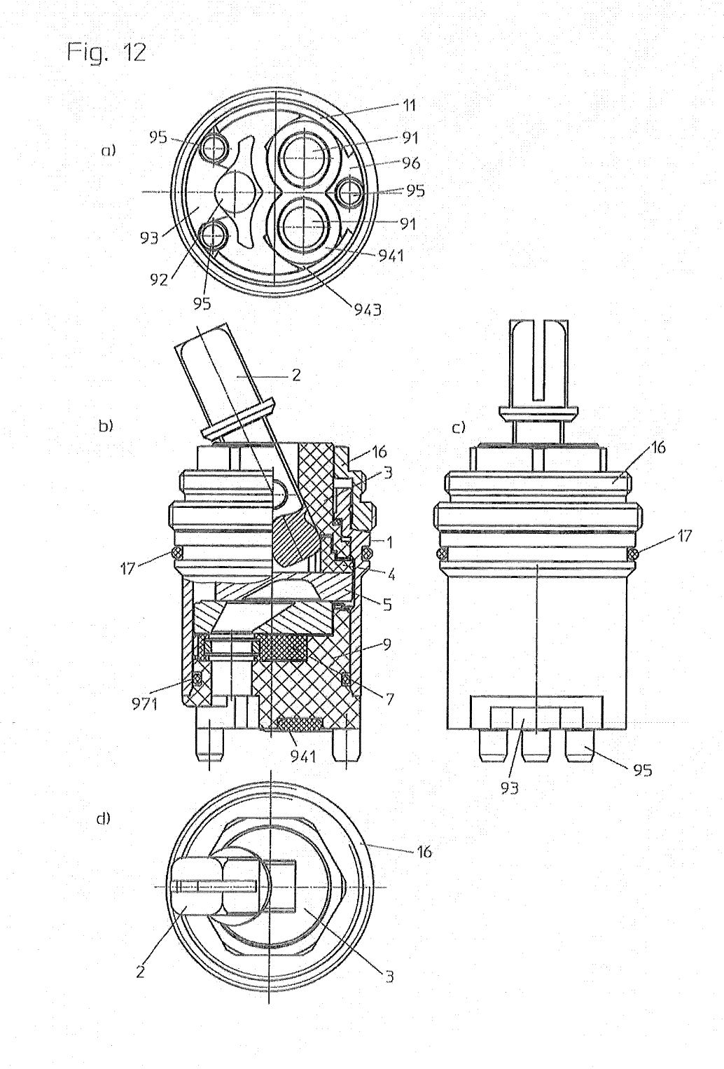

FIG. 12 the schematic representation of a single-lever mixer cartridge in a further embodiment for a fitting having a discharge at the side
a) in a view from below;
b) in longitudinal section;
c) in a side view;
d) in a top view;

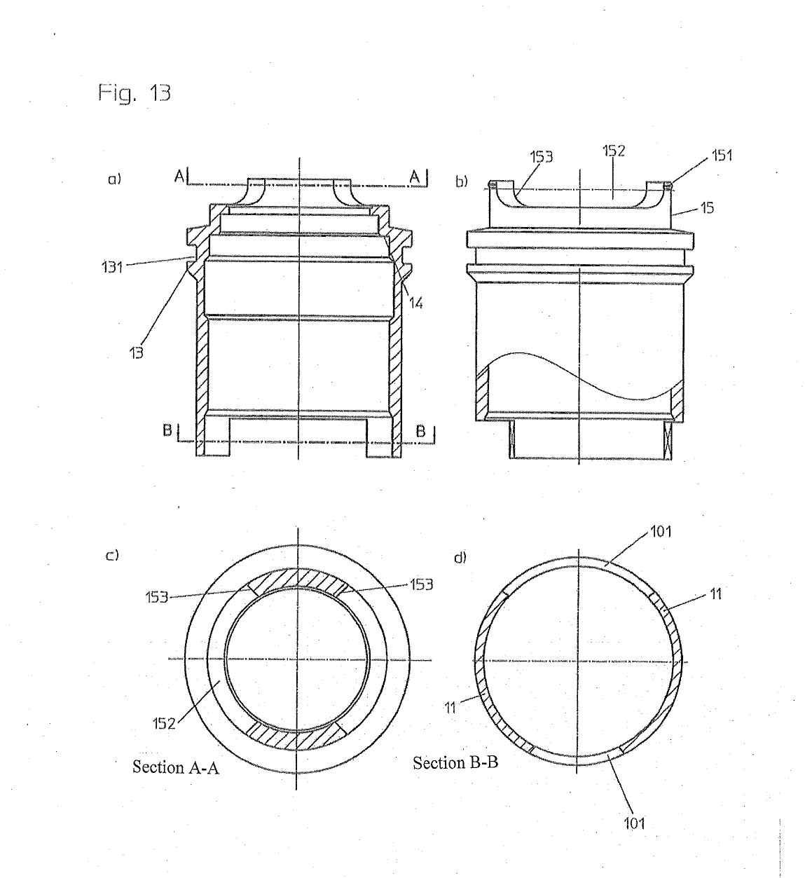

FIG. 13 the schematic representation of the head piece of the mixer cartridge from FIG. 12
a) in longitudinal section;
b) in partial section, in a side view rotated by 90°;
c) in cross-section (Section A-A);
c) in cross-section (Section B-B);

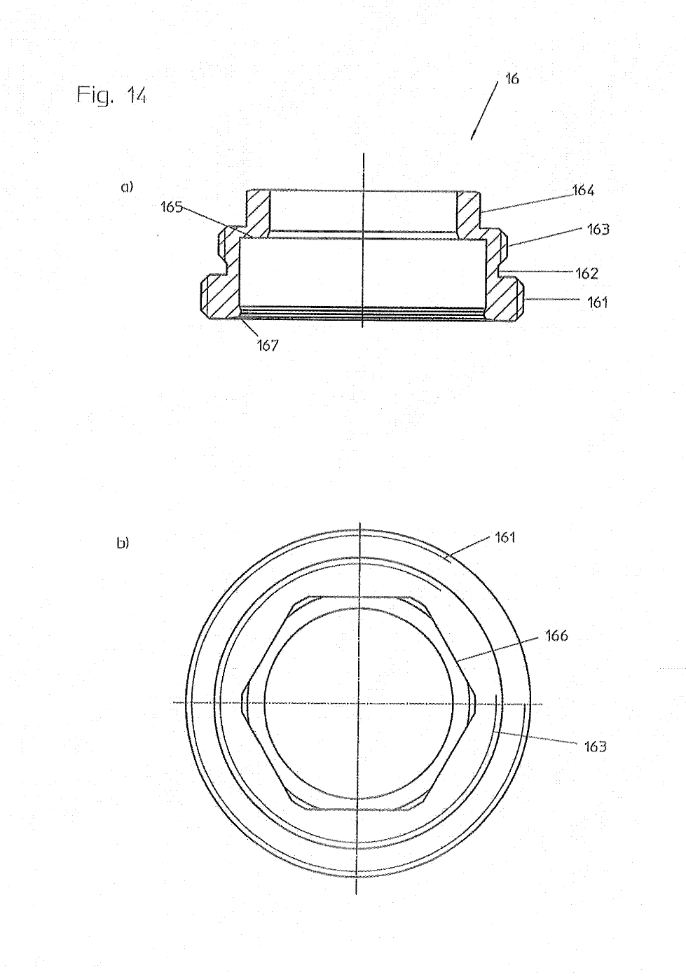

FIG. 14 the fastening ring of the mixer cartridge from FIG. 12
a) in longitudinal section;
b) in a top view;

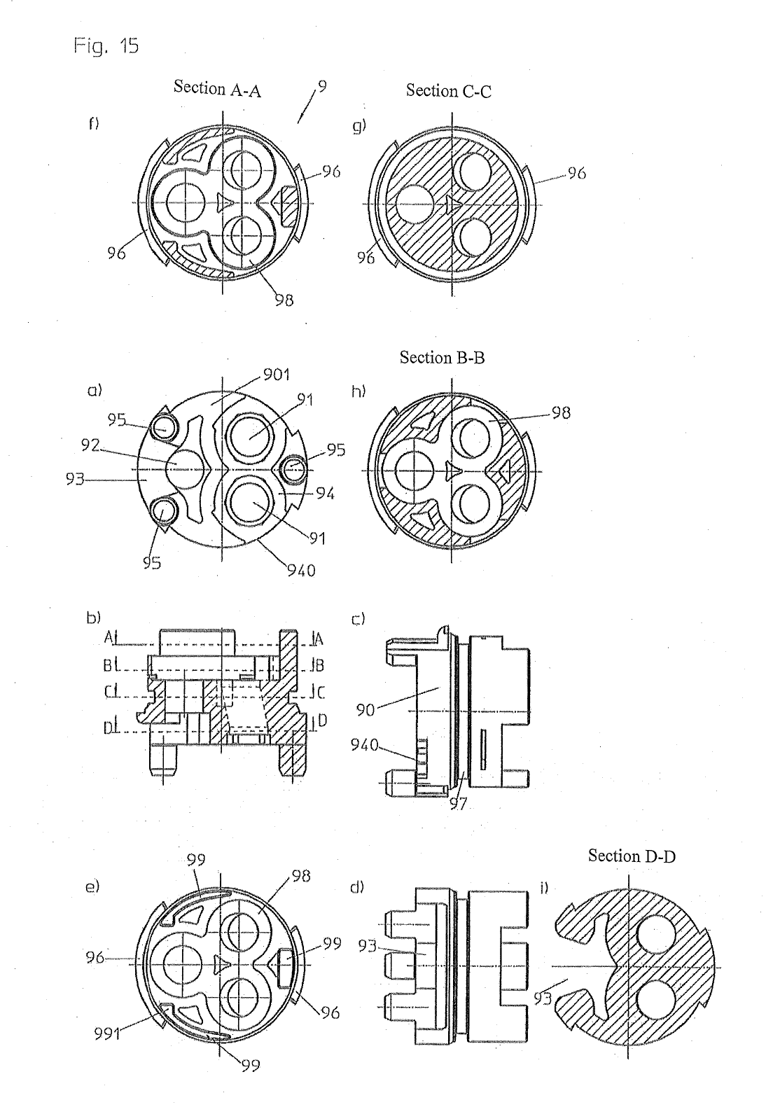

FIG. 15 the representation of the bottom piece of the mixer cartridge from FIG. 12
a) in a view from below;
b) in a partial sectional representation;
c) in a side view;
d) in a side view rotated by 90°;
e) in a top view;
f) in cross-section (Section A-A);
g) in cross-section (Section B-B);
h) in cross-section (Section C-C);
i) in cross-section (Section D-D);

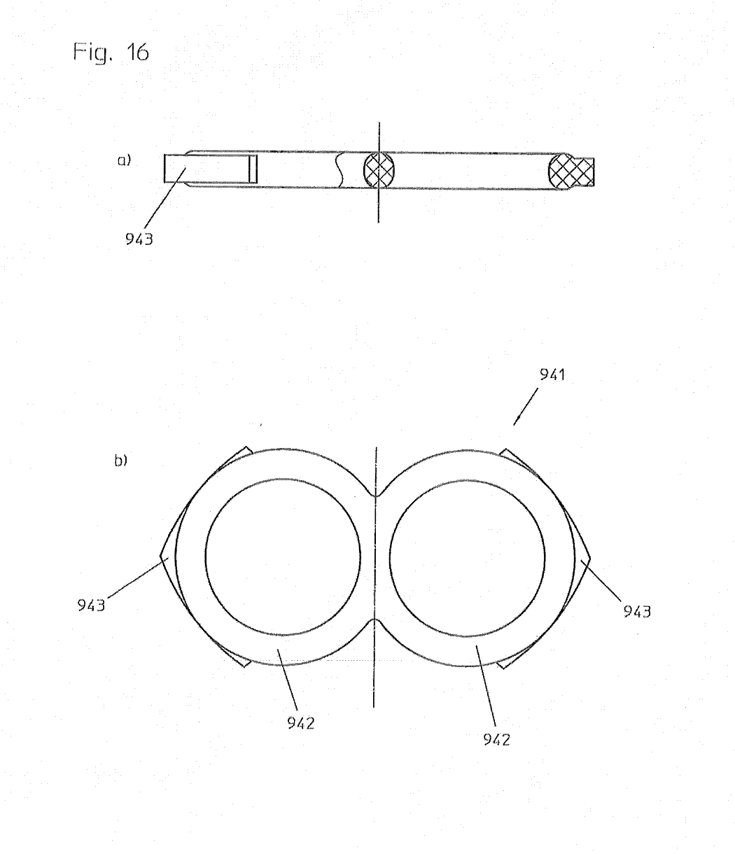

FIG. 16 the representation of the molded lip seal part of the mixer cartridge from FIG. 12
a) in a side view, in partial section;
b) in a top view.

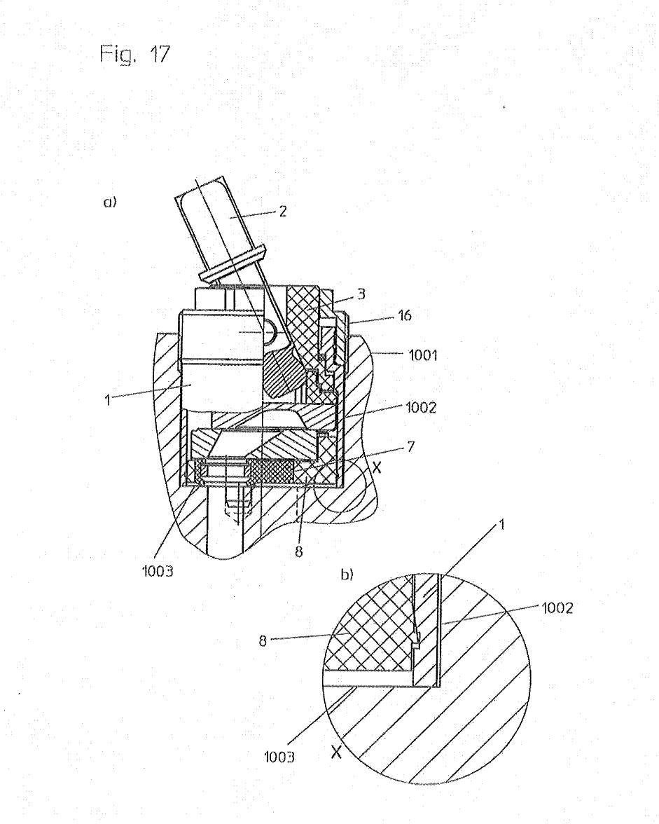

FIG. 17 the representation of the mixer cartridge from FIG. 1 affixed in a fitting
a) in longitudinal section;
b) in a detailed representation of Detail “X”

The single-lever mixer cartridge selected as an exemplary embodiment essentially consists of a head piece 1, into which a spindle 2 projects axially, which spindle is mounted so as to pivot in a spindle accommodation 3 that is mounted so as to rotate, and engages into a slide piece 4 that is connected with a control disk 5 that corresponds with a pass-through disk 6, which is followed by a bottom piece 8, which accommodates a molded seal part 7.

The head piece 1 is configured in the manner of a sleeve and is produced as a lathed brass part in the exemplary embodiment. Two rectangular recesses 101 that lie diametrically opposite one another are formed on the head piece 1 at its end-side section 10 facing the bottom piece 8, which recesses are formed by two arc-shaped ridges 11, on the inner side of which an engagement groove 111 is introduced. At its end that lies opposite the ridges 11, the head piece 1 has a diameter-reduced section 15, onto which a projection 151 is formed circumferentially on the end side. In the diameter-reduced section 15, two recesses 152 are introduced diametrically opposite one another, by means of which two radial stops 153 are formed, in each instance. The stops 153 serve to limit the rotation of the spindle accommodation 3. On the inside, a step 14 is formed by means of the diameter-reduced section 15.

Furthermore, a fastening ring 16 is set over the diameter-reduced section 15 of the head piece 1. The fastening ring 16 has an outside thread 161 on the outside circumference, so as to be screwed into a fitting 1001. Above the outside thread 161, the fastening ring 16 is provided with an outside hexagon 166. Below the outside hexagon 166, a step 165 is formed in the fastening ring 16. At its end opposite the outside hexagon 166, a projection 167 is furthermore formed circumferentially on the inside of the fastening ring.

In the exemplary embodiment, the spindle 2 is configured essentially in block shape. Approximately in the center of the spindle 2, a coaxial, formed-on part 21 in the shape of a circular ring, for accommodating an operating part—not shown—is formed. Above the formed-on part 21, a slot 25 guided all the way to the formed-on part 21 is introduced into the spindle 2. Below the formed-on part 21, a bore 22 for accommodating an axial pin 23 is introduced through the spindle 2. At the end, a control head 24 configured in the manner of a spherical disk is formed onto the spindle 2, which head is configured to be flattened on its side facing the slide piece 4.

The spindle accommodation 3 is configured as an essentially cylindrical plastic injection-molded part. On its end facing the slide piece 4, a two-level step 31 is formed on the spindle accommodation 3, the contour of which step corresponds to the inside contour of the two-level step 14 of the head piece 1, against which it lies. Above the two-level step 31, a radial passage bore 32 for accommodating the axial pin 23 for the spindle 2 is introduced through the spindle accommodation 3. A passage 33 for the spindle 2 is formed axially through the spindle accommodation 3, which passage has lateral stops 34 by means of which the pivot radius of the spindle 2 about the axial pin 23 is limited. The passage 33 opens into an essentially block-shaped accommodation 35 for the slide piece 4. At a distance from the accommodation 35, an essentially oval indentation 36 for accommodating the guide pin 44 of the slide piece 4 is introduced into the spindle accommodation 3.

The slide piece 4, which is structured as a plastic injection-molded part, is configured essentially in the form of a circular disk on which an essentially block-shaped molded piece 41 is formed. The molded piece 41 is configured in such a manner that it can be displaced within the accommodation 35 of the spindle accommodation 3, in the longitudinal direction, and is guided in the transverse direction. An oblong hole 42 for accommodating the control head 24 of the spindle 2 is introduced axially through the slide piece 4, penetrating the molded piece 41. To the side of the molded piece 41, a guide pin 44 for engagement into the indentation 36 of the spindle accommodation 3 is formed on. On its underside, which is directed opposite the molded piece 41, two axial ridges 43 for accommodating the control disk 5 are formed on the slide part 4, circumferentially on the outside, lying opposite one another. Furthermore, an alignment pin 45 for engagement into the alignment bore 53 of the control disk 5 is formed onto the underside, thereby guaranteeing correctly positioned orientation of the control disk 5 during assembly.

The control disk 5 is configured in oval shape and produced as a ceramic part. On its side facing the pass-through disk 6, the control disk has an egg-shaped indentation 51 disposed centrally. On its top, opposite the indentation 51, two recesses 52 for accommodating the ridges 23 of the slide piece 4 are introduced in the control disk 5, diametrically opposite one another on the outside. Furthermore, an alignment bore 53 is introduced into the control disk 5 on its side facing the slide piece 4. The control disk 5 is connected with the slide piece 4 with shape fit, by way of the recesses 52 as well as the alignment bore 53.

The pass-through disk 6 is also structured as a ceramic part. Two inlet channels 61 for cold and hot water, respectively, as well as an outlet channel 62, configured to be enlarged relative to the former, for the mixed water are introduced through the pass-through disk 6. The inlet channels 61 as well as the outlet channel 62 are passed through the pass-through disk 6 at a slant relative to the latter. At the sides, three recesses 63 for a shape-fit connection with the bottom piece 8 are introduced on the pass-through disk 6, offset relative to one another.

The molded seal part 7 is produced from rubber in the exemplary embodiment. It is formed essentially by three rings 71 that are formed onto the two other rings 71, in each instance, so that a clover-leaf contour is formed. Sealing lips 72 are formed on the rings 71 of the molded seal part 7, on its top and on its bottom, in each instance. For shape stabilization, the rings 71 are provided with a support ring 73, in each instance, which is disposed between the sealing lips 72 of the rings 71.

The bottom piece 8 is configured essentially cylindrically. A clover-leaf-like accommodation for the molded seal part 7 is formed in the center of the bottom piece 8. Three ridges 82 for torque-proof accommodation of the pass-through disk 6 are formed on circumferentially around the accommodation 81, at a distance from one another. The ridges 82 engage into the recesses 63 of the pass-through disk 6. To improve the shape fit, projections 821 are formed on two ridges 82, which projections engage into corresponding recesses 63 of the pass-through disk 6. At the side, two steps 83 for engagement into the recesses 101 of the end-side section 10 of the head piece 1 are formed on the bottom piece 8, diametrically opposite one another. On its underside, opposite the ridges 82, two axial positioning pins 84 are furthermore formed on the bottom piece 8. The positioning pins 84 serve for positioning of the single-lever mixer cartridge in a fitting—not shown—that is provided with corresponding positioning bores for this purpose. Engagement projections 85 that allow an engagement connection between the bottom piece 8 and the head piece 1 are formed circumferentially on the bottom piece 8. The engagement projections engage into the engagement groove 111 of the arc-shaped ridges 11 of the head piece 1.

In the assembled state, the steps 83 of the bottom piece 8 engage into the recesses 101 of the head piece 1. In this connection, the arc-shaped ridges 11 of the end-side section 10 of the head piece 1 project beyond the bottom surface 80 of the bottom piece 8 by 0.3 millimeter. The two positioning pins 84 project out of the bottom surface 80 for positioning of a fitting—not shown.

The mixer cartridge is connected—as shown in FIG. 17—with the fitting 1001 by way of the fastening ring 16, and biased against the valve seat 1003 of the cartridge accommodation 1002 of the fitting. Bias forces achieved in this way are transferred to the valve seat 1003 by means of the head piece, by way of the end-side section 10, which projects beyond the bottom surface 80 of the bottom piece 8.

The fastening ring 16 is set onto the diameter-reduced section 15 of the head piece 1, wherein the circumferential projection 151 is forced elastically inward when it passes over the circumferential projection 167 of the fastening ring 16. After having passed the projection 167 of the fastening ring 116, the projection 151 of the diameter-reduced section 15 of the head piece 1 assumes its original position once again. The fastening ring 16 is thereby captively held on the head piece 1. Screwing the fastening ring 16 into the fitting 1001 takes place by way of the outside hexagon 166.

In the exemplary embodiment according to FIG. 12, the single-lever mixer cartridge is configured for fittings having a side water discharge. In this connection, a circumferential step 13 increased in diameter is disposed on the head piece 1, in which step a groove 131 for accommodation of an O-ring 17 is introduced centered circumferentially. Above the step 14, a diameter-reduced section 15 is disposed, on which a projection 151 is formed circumferentially on the end side. In the diameter-reduced section 15, two recesses 152 are also introduced, diametrically opposite one another, by means of which two radial stops 153 are formed, in each instance, which serve to limit the rotation of the spindle accommodation 3. On its end-side section 10, two recesses 101 are introduced into the head piece 1, opposite one another, by means of which arc-shaped ridges 11 are formed. The recesses 101 are configured to be rectangular and to have different widths but the identical height.

A fastening ring 16 is set onto the diameter-reduced section 15 of the head piece 1, which ring has a first outside thread 161 on the outside circumference, so as to be screwed into a fitting—not shown. Above the first outside thread 131, a diameter-reduced step 62 is disposed, which is provided with a second outside thread 163. On the end side, a diameter-reduced section 164 is formed on the fastening ring 16, by means of which section a step 165 is formed. On the outside, the diameter-reduced section 164 is also provided with an outside hexagon 166. On its end opposite the diameter-reduced section 164, a projection 167 is furthermore formed on the inside of the fastening ring, also circumferentially.

The bottom piece 9 is configured essentially cylindrically. Two inlet bores 91 as well as an outlet bore 92 are introduced into the bottom piece 9; their center axes delimit an isosceles triangle. The outlet bore 92 opens into a protrusion 93 that extends over the outer mantle 90 of the bottom piece 9. The protrusion 93 allows sufficient water inflow for a side outlet channel of a fitting—not shown. The two inlet bores 91 are edged by a spectacles-shaped groove 94, which serves to accommodate a molded seal part 941. The groove 94 is positioned in such a manner that the delimitation edge that surrounds it runs through the center point of the bottom surface 901 of the bottom piece 9. Flanking the protrusion 93 as well as lying opposite it, three axial positioning pins are formed on the bottom piece 9.

In the exemplary embodiment, the molded seal part 941 is produced from rubber. It is essentially formed by two rings 942 that are formed onto one another, so that a spectacle-shaped contour is formed. On the outside, alignment lips 943 are formed on the molded seal part, which lips lie against the lateral broken-out regions 940 of the groove 94. The outside contour of the alignment lips 943 is configured in such a manner that it fits into the contour of the outer mantle 90 of the bottom piece 9.

On the side, two steps 96 are formed on the bottom piece 9, opposite one another, which steps correspond with the recesses 101 of the head piece 1 and engage into them. Above the steps 96, a groove 97 is circumferentially introduced for accommodation of an O-ring 971 for sealing the bottom piece 9 relative to the head piece 1. On its top, lying opposite the groove 94, the bottom piece 9 has a cloverleaf-like accommodation 98 for the molded seal part 7. Three ridges 99 for torque-proof accommodation of the pass-through disk 6 are formed on circumferentially around the accommodation 98, uniformly spaced apart from one another. The ridges 99 in turn engage into the recesses 63 of the pass-through disk 6. To improve the shape fit, once again projections 991 are formed onto two ridges, which projections engage into corresponding recesses 63 of the pass-through disk 6.

The single-lever mixer cartridge structured in this way is introduced into a fitting—not shown—having a cartridge accommodation, at the open end of which an inside thread for screwing in the fastening ring 16 of the head piece 1 is introduced. On the bottom side, two water inflow connectors open into the cartridge accommodation of this fitting—not shown—in a valve seat, which connectors are sealed relative to the inlet bores 91 by way of the molded seal part 941, and surrounding which connectors a planar contact surface is disposed, for contact of the end-side section 10 of the head piece 1. The head piece 1 is braced against the contact surface of the valve seat by way of the fastening 16 screwed into the fitting—not shown—wherein the bracing forces are transferred directly to the contact surface by way of the head piece 1. Furthermore, a side water discharge connector is provided. The mixed water gets into the space of the cartridge accommodation through the outlet bore 92, by way of the protrusion 93, and, by way of this space, into the side water discharge connector.

By means of the configuration, according to the invention, of the bottom piece, beyond which the arc-shaped ridges 11 of the end-side section 10 of the head piece 1 project, a very compact structure is made possible for this single-lever mixer cartridge, which is designed for side discharge. By means of the two broken-out regions 940 of the groove 94, into which the alignment lips 943 of the molded seal part 941 engage, a very space-saving configuration of the bottom piece 9 is achieved. A continuous groove for accommodation of the molded seal part 941 is not necessary in the present case, because the groove delimitation is formed by the bottom-shaped ridges 11 of the head piece 1 in the region of the broken-out regions 940.

1-9. (canceled)

10. Fitting having a cartridge accommodation having a valve seat, into which accommodation a single-lever cartridge is introduced, which fitting comprises a head piece (1) configured in the manner of a sleeve, which accommodates a bottom piece (8, 9), as well as having a disk controller having a control disk (5), which is disposed so that it can be rotated and/or displaced, by way of a spindle (2) mounted so that it can be rotated and/or pivoted, relative to a pass-through disk (6) that corresponds to the spindle, which pass-through disk (6) the bottom piece (8, 9) follows, wherein the head piece 1 is braced against the valve seat by way of a fastening ring (16) that engages around the head piece (1) on the outside, wherein the end-side section (10) of the head piece (1) that accommodates the bottom piece (8, 9) is configured in such a manner that it projects beyond the bottom surface (80, 901) of the bottom piece (8, 9) that faces away from the control disk (5), at least in certain regions, and wherein the bottom piece (8, 9) does not project beyond this section (10) at any point, wherein the valve seat has a planar contact surface, on which the end-side section of the head piece lies, in such a manner that the vertically acting bracing forces are transferred to the contact surface directly by way of the head piece (1).

11. Fitting according to claim 10, wherein the bottom piece (8) accommodates at least one seal for a sealing effect relative to a valve seat of a fitting, which seal projects beyond the end-side section (10) of the head piece (1).

12. Fitting according to claim 11, wherein the mantle surface (90) of the bottom piece (9) is formed, in certain regions, by a section of a seal (941).

13. Fitting according to claim 10, wherein the seal is formed by a molded seal part (7, 941) that has at least two circular pass-throughs.

14. Fitting according to claim 11, wherein the bottom piece (8, 9) is configured in such a manner that the center point of the bottom piece (8, 9) lies on the plane of its bottom surface (80, 901) and is not formed by a seal.

15. Fitting according to claim 10, wherein the mixer cartridge is configured as a side discharge valve.

16. Fitting according to claim 10, wherein the head piece (1) is configured as a lathed brass part.
